(19) United States
(12) Patent Application Publication
(10) Pub. No.: US 2010/0237168 A1
(43) Pub. Date: Sep. 23, 2010

(54) MISTER DEVICE AND METHOD FOR MISTING

(76) Inventor: Eric Cooper, New York, NY (US)

Correspondence Address: DICKSTEIN SHAPIRO LLP, 1633 Broadway, NEW YORK, NY, 10019, US

(21) Appl. No.: 12/406,706

(22) Filed: Mar. 18, 2009

(51) Int. Cl. B67D 5/08

(52) U.S. Cl. 239/72

(57) ABSTRACT

A misting device including a mister configured to mist water and at least one of a sound emitter, configured to generate one or more sounds, and a display, configured to generate one or more images. The generation of the one or more sounds and/or the one or more images is timed based on operation of the mister. The sound and/or images may be used, for example, to mentally prepare a pet for misting and/or to calm a pet during or after misting.

### CROSS-REFERENCE TO RELATED APPLICATIONS

Not Applicable.

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not Applicable.

### INCORPORATION-BY-REFERENCE OF MATERIAL SUBMITTED ON COMPACT DISC

Not Applicable.

### BACKGROUND OF THE INVENTION

(1) Field of the Invention

The present invention generally relates to misters.

(2) Description of Related Art

Misting devices exist for use in bird cages, terrariums, aviaries, indoor gardens, etc.

Misting pet birds, for example, can provide multiple benefits. In addition to the general enjoyment experienced by the pet, misting can invigorate the bird's skin and promote healthy preening of the feathers, leading to reduced feather picking and plucking. Misting is especially important for birds that are molting, as it may help loosen the keratin sheath that covers new pinfeathers, which facilitates sheath removal during normal preening behavior. Misting can also improve a bird's respiratory health. Notwithstanding these benefits of misting, pet birds may become apprehensive at the onset of misting.

### BRIEF SUMMARY OF THE INVENTION

A misting device according to an exemplary embodiment of the present invention includes a mister configured to mist water, and at least one of: (a) a sound emitter, such as a speaker, configured to generate one or more sounds; and (b) a display, such as a liquid crystal display, an organic light emitting diode display, a monitor, and a television, etc., configured to generate one or more images. The generation of at least one of the one or more sounds and the one or more images may be timed based on operation of the mister. For example, the sounds and images may be generated at least one of: (a) a predetermined period before the mister begins misting; (b) a predetermined period after the mister begins misting; and (c) a predetermined period after the mister stops misting.

According to an exemplary embodiment, the mister device may be configured to vary misting parameters over a misting session.

According to an exemplary embodiment, the mister device may further include a fluid source, a pump, and a nozzle. The pump may be configured to draw a fluid from the fluid source and force it through the nozzle so as to form a fluid mist.

According to an exemplary embodiment, the mister device may further include a controller configured to control operation of the mister and at least one of the sound emitter and display.

According to an exemplary embodiment, the mister device may further include a memory element used to store at least one of the one or more sounds and the one or more images.

According to an exemplary embodiment, at least one of the one or more sounds and the one or more images are pre-recorded by a user of the misting device.

According to an exemplary embodiment, the fluid source may be positioned above the pump so as to minimize the energy required to mist the fluid in the fluid source.

According to an exemplary embodiment, the misting device may be configured to attach to a cage, e.g., using hooks, Velcro, or suctions cups, such that mist generated by the mister is directed inside the cage.

According to an exemplary embodiment, the mister device may further include a microphone. The misting device may be configured to store audio picked up by the microphone and play back such audio using the sound emitter.

According to an exemplary embodiment, the mister device may be configured to generate a mist at predetermined time intervals and further configured to begin playing the audio using the sound emitter a predetermined period prior to the onset of misting.

According to an exemplary embodiment, the mister device may further include a control panel with a user interface configured to accept input from a user concerning at least one of (a) misting parameters, (b) the one or more sounds, and (c) the one or more images.

A method for misting according to an exemplary embodiment of the present invention includes (i) at least one of displaying an image and playing a sound, and (ii) generating a mist. The timing of the displaying and the playing may be based on a timing of the mist generating.

According to an exemplary embodiment, at least one of the displaying and playing is one of (i) started a predetermined period before the onset of the mist generating, (ii) started a predetermined period after the onset of the mist generating, and (iii) started a predetermined period of time after the end of the mist generating.

According to an exemplary embodiment, the method further includes accepting input from a user concerning one or more misting parameters, e.g., such as mist pressure, mist duration, and mist frequency.

According to an exemplary embodiment, the method further includes recording at least one of the image and sound.

According to an exemplary embodiment, the method further includes cancelling or minimizing noise created by the pump or other parts of the misting device using sound dampening material around the pump or other parts of the misting device and/or using an active sound cancellation device, which cancels such noise, for example, by creating and sound waveform opposite to the noise.

A method for training a pet according to an exemplary embodiment of the present invention includes at least one of (i) misting the pet upon detection of a predetermined sound generated by the pet, (ii) spraying the pet with a stream of water upon detection of a the predetermined sound.

Reference throughout this specification to “an embodiment” or “an exemplary embodiment” means that a particular feature, structure, or characteristic described in connection with the embodiment is included in at least one embodiment of the present invention. Thus, the appearances of these phrases in various places throughout this specification are not necessarily all referring to the same embodiment. Furthermore, the particular features, structures, or characteristics may be combined in any suitable manner in one or more embodiments.

An example embodiment of the present invention is described in more detail below with reference to the appended Figures. The foregoing description and examples have been set forth as mere illustrations and are not intended to be limiting. Each of the disclosed aspects and embodiments may be considered individually or in combination with other aspects, embodiments, and variations thereof. The steps of the methods described herein are not confined to any particular order of performance.

### BRIEF DESCRIPTION OF THE SEVERAL VIEWS OF THE DRAWINGS

FIG. 1 is a perspective view of the mister according to an exemplary embodiment of the present invention attached to a bird cage.

FIG. 2 is a block diagram of the mister according to an exemplary embodiment of the present.

### DETAILED DESCRIPTION OF THE INVENTION

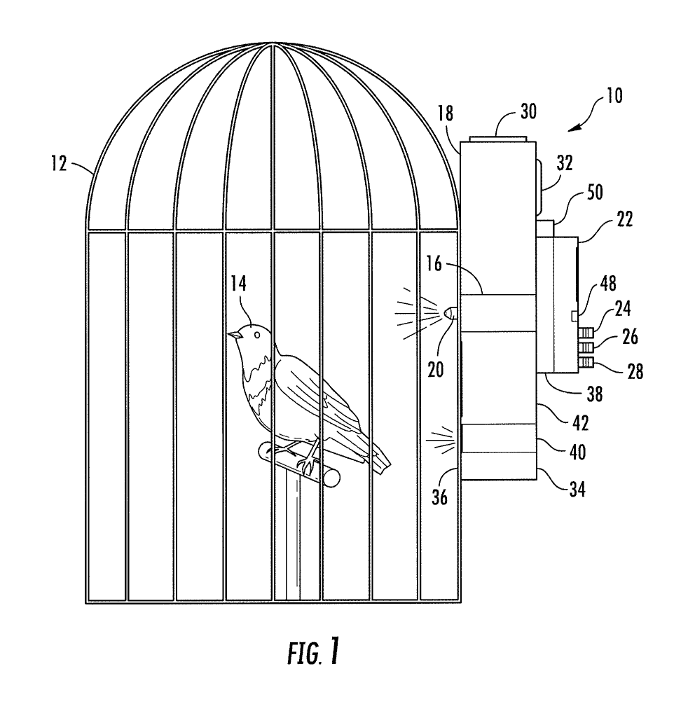

FIG. 1 illustrates a misting device 10 according to an exemplary embodiment of the present invention connected in a vertical orientation to the outside of a cage 12. The misting device is configured to mist an animal, such as bird 14, a reptile, or a plant in the cage 12.

The misting device 10 may also be suspended horizontally from a bottom of the cage 12, or sit horizontally on top of the cage, e.g., in the domed structure or on top of a flat cage. The misting device 10 includes an electric pump 16 for forcing liquid, such as water, in a reservoir 18 through nozzle 20 so as to form a mist. Alternatively, or in addition to the electric pump 16, the misting may be generated using a spray bottle. An automated mechanism, for example, may be used to repeatedly squeeze the trigger or handle on the spray bottle, so as to force pressurized fluid through a nozzle and generate a mist. Further, a pressurized fluid source may be used to generate the mist. A valve at the outlet to the pressurized fluid source and in communication with a nozzle may be opened and closed so as to initiate and suspend misting.

A control panel 22 includes knobs 24, 26, and 28 to control the duration of the mist, the frequency of misting, and the pressure, respectively. The control panel may also include buttons, switches, levers, and/or a touch screen for user interface. The misting device 10 is mounted on the cage 12 using hooks 36 but may be connected using other known connectors, such as suction cups and Velcro.

The misting device 10 is powered by a power source 23, e.g., batteries, in battery compartment 34. Alternatively, misting device 10 may be powered from an exterior source and, may have a jack to accept power from such power source.

Reservoir 18 includes removable, e.g., screw on, covers 30 and 32 on two sides. Cover 30 may be removed to refill the reservoir 18 when the misting device 10 is in the vertical position of FIG. 1 and cover 32 may be removed to refill reservoir 18 when the misting device 10 is in the horizontal configuration on top of the cage 12 or suspended from the bottom of the cage 12.

Nozzle 20 may have an adjustable head so as to allow a user to direct the mist in a preferred direction. Pump 16 may also be connected to a handheld nozzle accessory connected to the pump 16 via a tube (not shown) allowing the user to direct the mist in a direction of his or her liking both inside and outside of the cage 12. Additional nozzles may be connected at different positions on the cage 12. The additional nozzles may be connected to the pump via tubes, which may run along the wall of the cage 12. For example, one additional nozzle may be connected to a bottom of the cage 12 pointing in an upward direction to mist an underside of the bird 14. Misting from each nozzle may be simultaneous or staged depending on the needs of the bird 14 and/or the desire of the user.

To minimize expense and complexity, nozzle 20 may be connected directly to pump 16, as illustrated in FIG. 1. Alternatively, nozzle 20 or may be connected to pump 16 via an intermediary tube, which allows the nozzle to be spaced away from the pump 16.

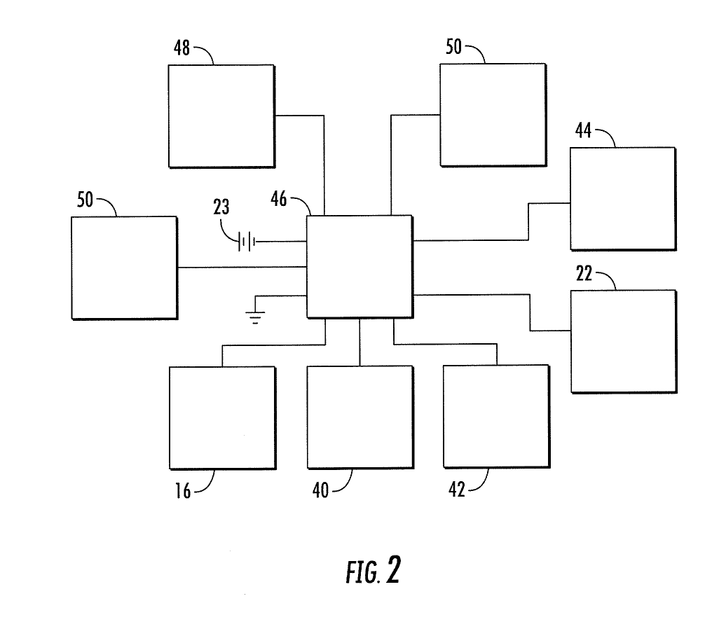

FIG. 2 illustrates a block diagram of the control circuit 38 used to control the pump 16 for misting. A control element 46 in communication with the control panel 22 and the pump 16 controls misting parameters such as the frequency and duration of misting, e.g., by controlling the level of current and/or voltage delivered to the pump 16 or by sending a control signal to the pump 16. The control element 46 may also control other misting parameters such as the pressure and the fineness of the mist. A microprocessor, for example, such as are well known and commercially available, may be used for the control element 46. The control circuit 38 is powered by a power source 23, e.g., batteries. Control element 46 may be used to route power to each of the components requiring power. Alternatively, power source 23 may communicate independently with each component requiring power.

In an exemplary embodiment of the invention, the control element 46 may also control a level of additive added to the mist. The additive may include, but is not limited to, an oil used to maintain a shiny and healthy plumage. The oil may be stored in an additive reservoir (not shown) and passed into the water in the fluid reservoir via control of a valve in communication with the control element 46. The valve may be controlled by a knob or button, etc. on the control panel 22. The additive may also be added manually to the reservoir 18 by a user.

The misting device 10 may include multiple different nozzles, for example, each having different size apertures and, thus, adapted to achieve a different mist fineness. The control element 46 may control a valve (not shown) to each of these different nozzles so as to allow for flow through only one at a time. Alternatively, flow may be provided through more than one nozzle simultaneously, which may be useful to achieve an intermediary mist fineness or other mist characteristic and also to provide for misting from multiple directions.

The misting device 10 may further include a sound emitter 40, such as a speaker, and a display 42, such as a liquid crystal display, an organic light emitting diode display, a monitor, or television. The display 42 may also be a movable panel, similar to those used in billboards, with multiple images that are swapped periodically by shifting of the panel. The sound emitter 40 and the display 42 communicate with and are controlled by the control element 46. The control panel 22, also in communication with the control element 46, may be employed by a user to enter control preferences for the sound emitter 40 and/or display 42, both of which may be directed towards the inside of the cage 12 such that the bird 14 can see a light or an image generated on the display 42 and can hear a sound generated by the sound emitter 40. Pressing a button or turning a knob, for example, on the control panel 22 may cause the sound emitter 40 to play sounds and/or the display 42 to display an image, series of images, or video clips, all of which may be pre-recorded, e.g., by the user. The sounds, images, and video, as well as the user control preferences, may all be stored, for example, in a memory unit 44 also connected to the control element 46.

The control element 46 may play the sounds, images, and/or video stored, e.g., on the memory unit 44, at a predetermined time, at predetermined time intervals, and/or upon a triggering event. The control element 46 may be configured to play the sounds, images, and/or video (“media”) during or a predetermined time before or after the misting. For example, rather than surprise the bird 14 with a sudden misting, the control element 46 can be programmed to play a tranquil pre-recorded sound on the sound emitting device 10, e.g., birds chirping, leaves rustling, the user's voice, etc., at a predetermined time period, e.g., 5 seconds, before the onset of misting. The bird 14 may also be provided forewarning as to the ending of the misting by changing the projected sound just prior to the end of misting. The user may choose from multiple pre-recorded sounds and/or images to be played by the display 42 by adjusting settings via the control panel 22. The user may also choose when the media is played, e.g., randomly, at predetermined time intervals, a predetermined time before the onset of misting, at the onset of misting, a predetermined time period into misting, and a predetermined time period after misting, etc. The media may also be timed in connection with alternate misting session or every predetermined number of misting sessions. For example, to avoid over stimulation, the sound emitting device 10 and/or display 42 may be controlled by the control element 46 to play a pre-recorded message or video from the user just prior to the onset of every third misting session.

The control element 46 can also be programmed so as to instruct the pump 16 to provide a progressive build up in the mist pressure at the onset of misting and/or a progressive decline in the mist pressure towards the end of misting. The pump 16 may be controlled by varying the power delivered for pumping. The misting can be gradual, starting very fine and building up over a predetermined time period and the misting can then be tapered off so as not to excite or startle the bird 14 with abrupt changes. The control element 46 can also be programmed to cycle the misting through different stages in which the bird 14 is exposed to different water pressure, water volume, etc. The same type of progressive build up and tapering and/or stage cycling can be provided with respect to the media presentation. For example, the pre-recorded sounds can gradually build up in volume and/or taper off. Similarly, the brightness of the display 42 can gradually build up in volume and/or taper off.

The misting device 10 may include a microphone 48 in communication with the control element 46, which can be used to record sound pieces to be stored in the memory unit 44. The user may record sounds, including his or her own voice, via the control panel 22, to be played back to the bird, e.g., just prior to the onset of misting. The sound of the user's voice as played by the sound emitter 40 and/or the user's image as displayed by the display 42 may provide comfort to the bird 14 while the user is absent and, in particular, provide comfort or forewarning to the bird 14 during a change in environment such as a misting. The user's image may be taken by a digital camera or camcorder (not shown) in communication with control element 46. The misting device 10 may also have other inputs from sensors, such as a temperature reading from a temperature sensor or a humidity level reading from a humidity sensor. The control element 46 may be programmed to initiate and/or terminate misting depending on conditions such as temperature and humidity, etc.

Microphone 48 may also be used to pick up sounds generated by the bird 14. The control element 46 may be programmed to monitor such sound pickup and turn on the misting and/or play the media when a predetermined type of sound is detected. This feature would allow the highly intelligent bird to request, for example, a misting on demand. Further, this feature could be used to foster positive behaviors and to help eliminate negative behaviors. Desirable sounds generated by the bird 14 can be rewarded, for example, by generating a comfortable misting, sounds, and/or lights that comfort or soothe the animal. Undesirable sounds generated by the bird 14, on the other hand, can be trained away by exposing the bird 14 to unpleasant conditions, e.g., a high pressure water spray or a loud sound, immediately after making the undesirable sound.

As illustrated in FIG. 1, the misting device 10 is hung vertically on the cage 12. This orientation places the reservoir 18 above the pump 16 and takes advantage of gravity so as to decrease the amount of power necessary to pump the water through the nozzle for misting. The effect of gravity can be further taken advantage of by shifting the pump 16 and nozzle 20 to the bottom of the misting device 10.

In order to ensure the longevity of the misting device 10 and to further enhance the leisure time of the bird 14, a toy (not shown) may be suspended, e.g., from the bottom of the misting device 10, and hung inside the cage 12. In an exemplary embodiment, a rod may be connected adjacent one end to the misting device 10 and adjacent an opposite end to the toy. When the misting device 10 is not in the misting mode, the toy should occupy the bird 14's attention and prevent preoccupation and pecking by the bird 14 on the misting device 10 itself.

In an exemplary embodiment, the misting device 10 may be connectable, e.g., wirelessly or via a USB cable, to a computer so as to allow loading of media, including various sounds, images, and videos, etc. either directly onto control element 46 or stored in memory unit 44. Various misting schedules and cycles may also be loaded into the misting device 10.

In an exemplary embodiment, the misting device 10 may include a temperature control device 50 to control the temperature of the fluid in the fluid reservoir 18. The temperature control device 50 may also be used to control the temperature of the control circuit 38, e.g., so as to prevent overheating. The temperature control device may include a cooler and/or a heater, e.g., a fan or thermoelectric cooler, such as a Peltier cooler. The control element 46 may communicate with a temperature sensor and the temperature control device and may be programmed to change or maintain the temperature of the fluid according to pre-set instructions or input from the user via the control panel 22. For example, the control element 46 may be programmed to maintain the fluid reservoir temperature at room temperature or within a predetermined or preset temperature range. The temperature sensor may be used to measure the temperature of the control circuit 38 and/or the temperature of the fluid in the fluid reservoir 18 and communicate such readings to the control element 46.

In an exemplary embodiment, the misting device 10 may have pre-stored misting preferences for different animals, e.g., frequency, duration, temperature, media presented before during, or after misting, etc. The user need only identify the particular animal being misted via the control panel 22 and the misting device will automatically mist the animal consistent with such preferences.

In an exemplary embodiment, the misting device 10 may also include a heating or cooling element inside the cage 12 for heating and/or cooling the bird 14. Such heating or cooling element may communicate with the control element 46 and be timed based on the misting. For example, the control element 46 may be programmed to turn on a fan or sun/heat lamp, e.g., directed at the bird 14, for a predetermined period of time upon completion of misting or prior to the onset of misting or during misting, etc. Further, the control element 46 may instruct the sound emitter 40 and/or display 42 to generate the above-described media, e.g., sounds, images, video, a predetermined period prior to, during, and/or after turning on or off the heating and/or cooling element independent of or in conjunction with misting. In other words, as with the misting session, the timing of the heating and/or cooling session can be used as a trigger for generation of the media, e.g., to provide comfort to the bird 14 during a period of transition.

In an exemplary embodiment, the misting device 10 is used independent of the cage 12, e.g., to mist a plant. The misting device 10 may, for example, sit on a table adjacent the plant or be supported above by a hook.

In an exemplary embodiment, the misting device 10 provides for noise cancellation so as to assure an optimum environment for the bird 14. For example, an active noise cancellation device may be used to cancel noise created by the pump 16 or other parts of the misting device 10. The noise cancellation device may use any known noise cancellation technology. For example, U.S. Pat. Nos. 6,155,378 and 7,353,908, which relate to noise cancellation, are herein incorporated by reference in their entireties. In an exemplary embodiment, the noise cancellation device may create a sound waveform 180 degrees out-of-phase to that of the noise created by the sound emitting device 10 using, e.g., sound emitter 40. The sound cancellation device may be incorporated into the control element 46 or may comprise a separate device in communication with the control element 46. The microphone 48 may be used to sample background noise requiring cancellation. The misting device 10 may also include sound dampening material, e.g., insulation, over the pump 16 or other parts of the misting device 10 so as to muffle noise.

Those skilled in the art can appreciate from the foregoing description that the present invention can be implemented in a variety of forms. Therefore, while the embodiments of this invention have been described in connection with particular examples thereof, the true scope of the embodiments of the invention should not be so limited since other modifications and variations will become apparent to the skilled practitioner upon a study of the drawings and specification. Such modifications and variations are considered to be within the purview and scope of the appended claims and their equivalents.

What is claimed is:

1. A misting device comprising:
a mister configured to mist water, and
at least one of:
(a) a sound emitter configured to generate one or more sounds; and
(b) a display configured to generate one or more images;
wherein generation of at least one of the one or more sounds and the one or more images is timed based on operation of the mister.

2. The misting device according to claim 1, wherein the misting device is configured such that at least one of the one or more sounds and the one or more images are generated at least one of:
(a) a predetermined period before the mister begins misting;
(b) a predetermined period after the mister begins misting; and
(c) a predetermined period after the mister stops misting.

3. The misting device according to claim 1, wherein the mister device is configured to vary misting parameters over a misting session.

4. The misting device according to claim 1, wherein the mister device comprises a fluid source, a pump, and a nozzle, the pump configured to draw a fluid from the fluid source and force it through the nozzle so as to form a fluid mist.

5. The misting device according to claim 1, wherein the sound emitter comprises a speaker.

6. The misting device according to claim 1, wherein the display comprises one of a liquid crystal display, an organic light emitting diode display, a monitor, and a television.

7. The misting device according to claim 1, further comprising a controller configured to control operation of the mister and at least one of the sound emitter and display.

8. The misting device according to claim 1, further comprising a memory element storing at least one of the one or more sounds and the one or more images.

9. The misting device according to claim 1, wherein at least one of the one or more sounds and the one or more images are pre-recorded by a user of the misting device.

10. The misting device according to claim 4, wherein the fluid source is positioned above the pump.

11. The misting device according to claim 1, wherein the misting device is configured to attach to a cage such that mist generated by the mister is directed inside the cage.

12. The misting device according to claim 1, further comprising a microphone, the misting device configured to store audio picked up by the microphone and play back such audio using the sound emitter.

13. The misting device according to claim 12, wherein the misting device is configured to generate a mist at predetermined time intervals and further configured to begin playing the audio using the sound emitter a predetermined period prior to the onset of misting.

14. The misting device according to claim 1, further comprising a control panel with a user interface configured to accept input from a user concerning at least one of (a) misting parameters, (b) the one or more sounds, and (c) the one or more images.

15. The misting device according to claim 1, further comprising a noise cancellation device configured to at least one of (i) cancel or minimize at least one frequency of sound generated by the misting device, and (ii) cancel or minimize at least one frequency of sound generated by a source other than the misting device.
